(19) United States
(12) Patent Application Publication
(10) Pub. No.: US 2012/0049504 A1
(43) Pub. Date: Mar. 1, 2012

(54) IDENTIFICATION STRAP WITH TWO CLASPS

(75) Inventor: Sylvain Giraud, Echirolles (FR)

(73) Assignee: A. RAYMOND ET CIE, Grenoble (FR)

(21) Appl. No.: 13/201,126

(22) PCT Filed: May 6, 2010
(86) PCT No.: PCT/EP2010/002766

§ 371 Date: Aug. 11, 2011

(30) Foreign Application Priority Data
May 19, 2009 (FR) 0953342

(51) Int. Cl. B42D 15/00

(52) U.S. Cl. 283/75

(57) ABSTRACT

The invention relates to a strap (1) including a band (2) with two ends (3, 4) provided with a male portion (7) and a female portion (8) of a first closing member (5), respectively, which are intended to be inserted into one another so as to connect the two ends (3, 4) of the band in order to clasp the strap. The strap also includes a second closing member (6) with a male portion (9) and a female portion (10) intended to be inserted into one another, arranged at either end (3, 4) of the band (2), respectively, wherein the second closing member (6) at least partially surrounds the first closing member (5).

### CROSS-REFERENCE TO RELATED APPLICATION

This application is a U.S. National Phase Patent Application based on International Application Serial No. PCT/EP2010/002766 filed May 6, 2010, the disclosure of which is hereby explicitly incorporated by reference herein.

### BACKGROUND OF THE INVENTION

1. Field of the Invention

The present invention relates to a strap including a band with two ends provided with a male portion and a female portion of a first closing member, respectively, adapted to be inserted one into the other to connect the two ends of the band in order to close the strap.

2. Description of the Related Art

The invention more particularly relates to identification straps for animals, particularly game. Such an identification strap can, for example, be made mandatory to identify and control animals killed during the hunting season. In this case, the strap is adapted to be set in place on a member of the killed animal, for example through a hole made by means of a cut with a knife in a predetermined location of a leg of the animal, so as to band the animal. The closing of the strap on the leg of the animal is carried out by bringing the two ends of the strap closer together and then by inserting the male portion of the closing member into the female portion. It is to be understood that, to avoid any fraud, it is mandatory that the strap be designed so it cannot be easily removed and subsequently put back fraudulently, for example, on another animal, or that, in case the strap is removed and put back, there is a telltale on the strap showing this operation of removing and putting it back on.

Similar requirements are encountered for a use of the strap for the purpose of sealing objects such as a box or a packaging or any keeping device.

One known identification strap is disclosed in patent EP-1611784, in which the first closing member comprises two blades arranged in a housing forming the female portion and a lug provided with notches forming the male portion. Once the lug has been latched in the housing, it is impossible to take it out without damaging the strap. The reliability of this strap is increased by the presence on both sides of the lug by two flanges arranged to take place between the two blades, which prevents any rotational movement and thus limits the wear and tear of the lug and of the housing. However, making this strap requires a mold comprising two plates and two inner cores whose assembly kinetics is complex, which causes a substantial supplementary manufacturing cost.

An identification strap is also known from patent CH-667 773, which comprises, around the male portion, four bosses adapted to penetrate four associated grooves formed in the female portion to prevent the male and female portions from rotating with respect to one another, and thus increase the reliability of the strap. However, the band of the strap is made of plastic material in which the male and female portions are molded, the latter being made of metal, which makes for a bi-material assembly that is complex and costly to produce.

### SUMMARY OF THE INVENTION

The present invention provides a strap, and in particular an identification strap for animals, which is less costly and is easy to manufacture while providing increased protection against disassembly.

To this end, the present invention provides a strap including a band having two ends provided, respectively, with a male portion and a female portion of a first closing member adapted to be inserted one into the other to connect, between them, the two ends of the band in order to close the strap, characterized in that it further includes a second closing member with a male portion and a female portion adapted to be inserted one into the other, arranged respectively at the ends of the band and in that the second closing member surrounds at least partially the first closing member.

The present strap is thus a strap with two locks arranged with respect to one another so that one of the two locks blocks the access to the other lock when the strap is closed on itself. The two locks contribute to reinforcing the protection of the strap against disassembly and thus against fraud.

A strap according to the invention can advantageously have the following particularities:

the male and female portions of the first closing member comprise first notches having a locking position according to which they prevent withdrawal of the male portion of the first closing member from the female portion of the latter, the male and female portions of the second closing member comprising second notches having a locking position according to which they prevent withdrawal of the male portion of the second closing member from the female portion of the latter, the first and second closing members being arranged so as to lock simultaneously;

the first closing member comprises flexible notches along a certain direction and the second closing member comprises flexible notches along another direction, perpendicular to said certain direction;

the male portion of the first closing member with the female portion of the second closing member form a first closing assembly arranged at one end of the band and the male portion of the second closing member with the female portion of the first closing member form a second closing assembly arranged at the other end of the band;

it can be advantageous to provide, at each end of the band, a means for preventing a complete insertion of the male portion into the corresponding female portion of the closing members when the strap is closed on itself; this means can comprise a tab which is connected to the band by a divisible material area;

it can be advantageous to provide a means for keeping the strap closed on itself according to a transport position according to which the male and female portions of the closing members are not inserted one into the other;

a marking device of the type printed on one surface of the band, or even welded or over-molded in the band, can also be provided to serve to identify the banded animal with the strap, for example; and

the band with the closing members can advantageously be made in one piece, by molding a plastic material.

In one form thereof, the present invention provides a strap comprising a band with two ends provided, respectively, with a male portion and a female portion of a first closing member adapted to be inserted one into the other to connect the two ends of the band in order to close the strap, characterized in that it further comprises a second closing member with a male portion and a female portion adapted to be inserted one into the other, arranged respectively at the two ends of the band and in that the second closing member surrounds at least partially the first closing member.

### BRIEF DESCRIPTION OF THE DRAWINGS

The above mentioned and other features and objects of this invention, and the manner of attaining them, will become more apparent and the invention itself will be better understood by reference to the following description of embodiments of the invention taken in conjunction with the accompanying drawings, wherein:

FIG. 1 is a perspective view of an identification strap according to the invention;

FIG. 2 is a cross-sectional perspective view along the axis II-II of FIG. 1 of an end of the identification strap according to the invention;

FIG. 3 is a cross-sectional perspective view along the axis III-III of FIG. 1 of the other end of the identification strap according to the invention;

FIG. 4 is a cross-sectional perspective view along the axis III-III of FIG. 1 of the identification strap according to the invention in closed position with the first and second closing members latched one into the other;

FIG. 5 is a cross-sectional perspective view along the axis V-V of FIG. 1 of the identification strap according to the invention in closed position with the first and second closing members latched one into the other;

FIG. 6 is a side view of the identification strap according to the invention in an anti-locking position;

FIG. 7 is a side view of the identification strap according to the invention in a transport position; and

FIG. 8 shows the identification strap according to the invention in perspective, viewed from the other side with respect to FIG. 1.

Corresponding reference characters indicate corresponding parts throughout the several views. Although the exemplifications set out herein illustrate embodiments of the invention, in several forms, the embodiments disclosed below are not intended to be exhaustive or to be construed as limiting the scope of the invention to the precise forms disclosed.

### DETAILED DESCRIPTION

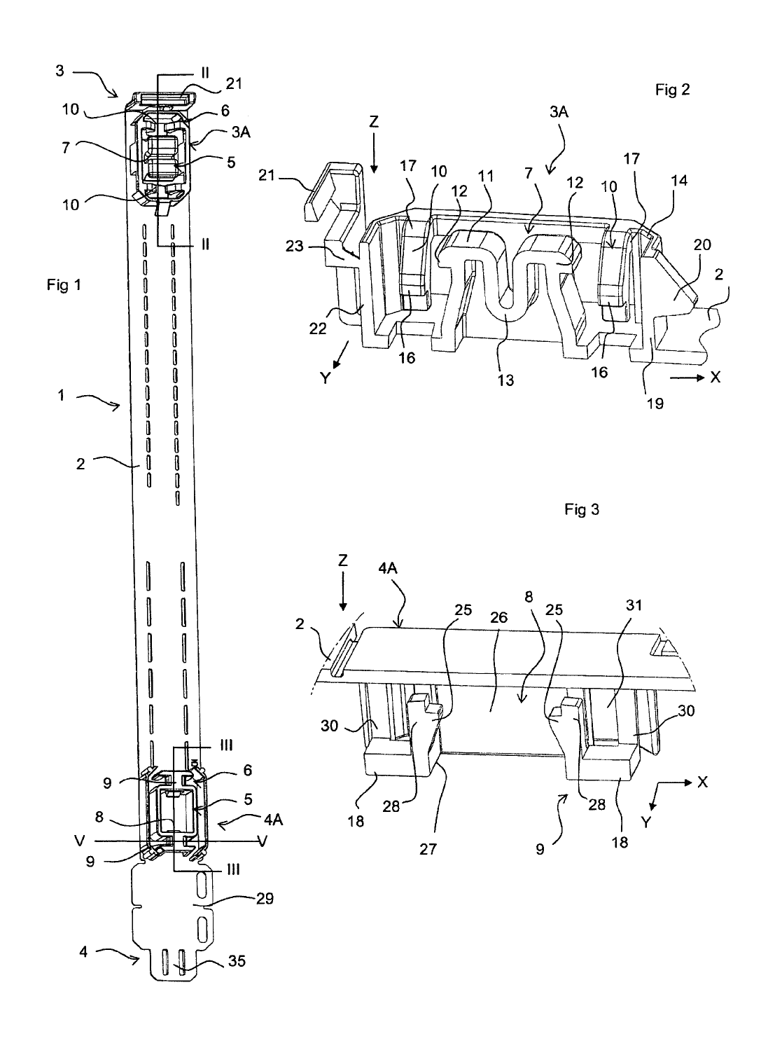

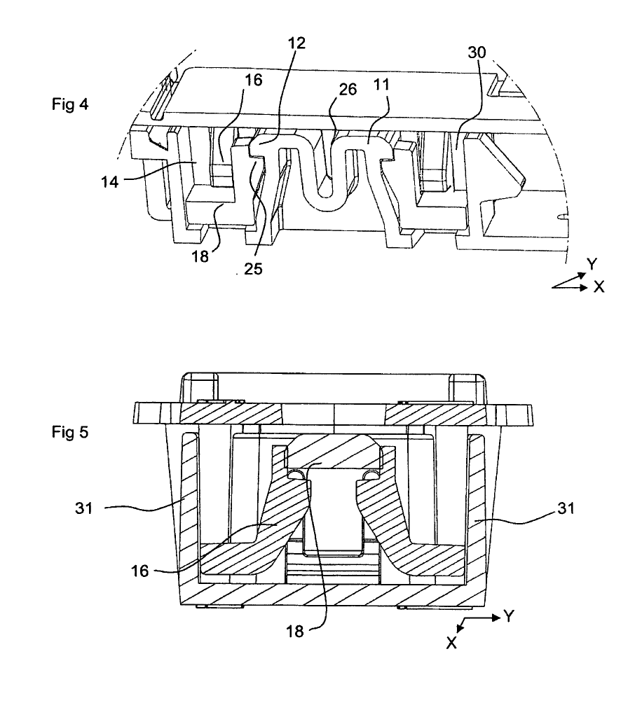

FIG. 1 shows an identification strap 1 for identifying animals according to the invention, including a flexible band 2, here in plastic material, for example having a substantially rectangular transverse section of small thickness, which extends along a longitudinal direction X between two opposite end portions 3, 4 onto which two closing members 5, 6 of the strap are arranged to connect the two end portions of the band to one another in order to close and lock the strap 1.

The two closing members 5, 6 are here arranged on the same side of the band 2 so that the strap closes on itself by folding flat.

The first closing member 5 comprises a male portion 7 and a female portion 8 arranged so as to be inserted one into the other along the direction Z (that is, substantially perpendicular to the band 2) when the two ends 3 and 4 are close to one another facing each other.

The second closing member 6 also comprises a male portion 9 and a female portion 10 arranged to be inserted one into the other in the direction Z when the portions 7 and 8 of the closing member 5 are also inserted one into the other.

The male portion 7 of the first closing member 5 and the female portion 10 of the second closing member 6 are here arranged on the same end 3 of the band 2 and form a first closing assembly 3A, whereas the female portion 8 of the first closing member 5 and the male portion 9 of the second closing member 6 are arranged on the other end 4 of the band 2 and form a second closing assembly 4A.

It is thus to be understood that these two closing assemblies 3A and 4A cooperate with one another at the same time to close the strap. As shown in FIG. 1, here, the female portion 10 surrounds the male portion 7 and the male portion 9 surrounds the female portion 8. Thus, generally, the second closing member 6 surrounds the first closing member 5 when the strap is closed on itself.

Subsequently in the description, the direction X must be considered as a mirror axis of symmetry of the strap according to the invention.

FIG. 2 shows the first closing assembly 3A which comprises the male portion 7 and the female portion 10. The male portion 7 is a mushroom-shaped lug 11 whose substantially parallelepiped head forms two rigid locking notches 12 which extend here in a Y direction perpendicular to the X direction and is provided with a deep central groove 13 which also extends in the Y direction. The groove 13 essentially plays the role of an aid for taking the strap out of the mold during manufacturing. The base of the lug 11 is constituted of the band 2 itself.

The female portion 10 is a frame 14 which surrounds the lug 11 and has two opposite lateral sides 15 provided with flexible notches 16 along the Y direction. Each notch 16 is in fact mounted on a flexible leg 17 in the area of a side 15 of the frame 14.

FIG. 3 shows the second closing assembly 4A which comprises the female portion 8 and the male portion 9. The female portion 8 comprises flexible notches 25 along the longitudinal direction X adapted to latch onto the rigid notches 12 of the male portion 7. These notches 25 are here arranged on two opposite lateral walls 27 of the frame 26. Each notch 25 is more particularly a part of a flexible leg 28 suspended from the frame 26. Here, the male portion 9 surrounds the female portion 8. More particularly, on the external side of the lateral walls 27, two rigid notches 18 raised with respect to the band 2, extend along the longitudinal direction X. Each notch 18 forms a sort of bridge or arch frame 30 affixed to the band 2.

As can be seen in FIG. 3, two full walls 31 bordering, along direction X, the notches 18 of the second closing member 6 are provided to prevent access to the latter when the strap is closed on itself.

To close and lock the strap 1, one only has to bend it at the center of the band 2, for example by bringing the two closing assemblies 3A, 4A closer together, then by engaging them one into the other along direction Z.

The lug 11 of the male portion 7 thus engages in the frame 26 of the female portion 8 at the same time as the bridge-shape structure 30 forming the male portion 9 engages into the frame 14 of the female portion 10. Then, the notches 25 lock themselves in the notches 12, which prevents withdrawing the male portion 7 from the female portion 8 in the direction, opposite the insertion direction along direction Z. Simultaneously, the notches 18 lock themselves in the notches 16, which also prevents the male portion 9 from withdrawing from the female portion 10 in the direction, opposite the insertion direction, along direction Z.

As shown in the drawings, the closing assemblies 3A and 4A have a hollowed out structure resulting from molding the strap in one piece out of plastic material. The edges 31 are arranged to run according to direction X, alongside the recesses present in the frame 14 of the female portion 10, which also prevents access from the outside to the notches 16 and 18. Subsequently, the frame 14 is arranged to run according to direction X, alongside the recesses present in the frame 26 of the female portion 8, which prevents the notches 25 and 12 to be accessed to from the outside. The closing assemblies 3A and 4A are in fact conformed when they are inserted one into the other to make a peripheral border preventing access to the locking notches of the closing members from the outside. In practice, as shown in the drawings, the flexible notches 25 of the first closing member deform along the direction X whereas the flexible notches 16 of the second closing member deform along the Y direction, that is, in a direction perpendicular to the deformation direction of the notches of the first closing member. The locking is thus sort of carried out along two perpendicular directions, which provides an enveloping protection to the closing members 5, 6.

FIG. 2 also shows that the strap according to the invention has, on the side of the assembly 3A, a tab 21 which extends perpendicularly to the band 2 and which projects with respect to the upper surface of the assembly 3A. This tab has an end arranged extending along the band 2 and a median portion connected to the outer surface 22 of the frame 14 by an area of divisible material 23. FIG. 6 shows the strap 1 closed on itself and shows how the tab 21 plays an anti-locking role to prevent an inopportune or involuntary locking of the closing members when the strap is closed on itself. It can be seen that the closing assembly 4A is arranged set back from the end of the strap 2 in the area of the end 4, thus leaving an end portion 29 of the band 2 free. A hinge area 29A of the band is provided between the end 4 of the band and the closing assembly 4A. When the strap is closed on itself and the closing assemblies 3A and 4A are inserted one into the other, the portion of the band 29 superposes with the tab 21, which prevents the complete insertion of the closing assemblies 3A and 4A. To carry out the complete insertion of the closing assemblies 3A and 4A, the tab 21 must be released from the frame 14 by cutting and tearing away the divisible material area 23. The tab 21 can then be arranged to be elastically forced to move away from the frame 14 by a rotational movement about the hinge area 24 and detached from the band 2. After this, the complete insertion of the closing assemblies 3A and 4A can be carried out.

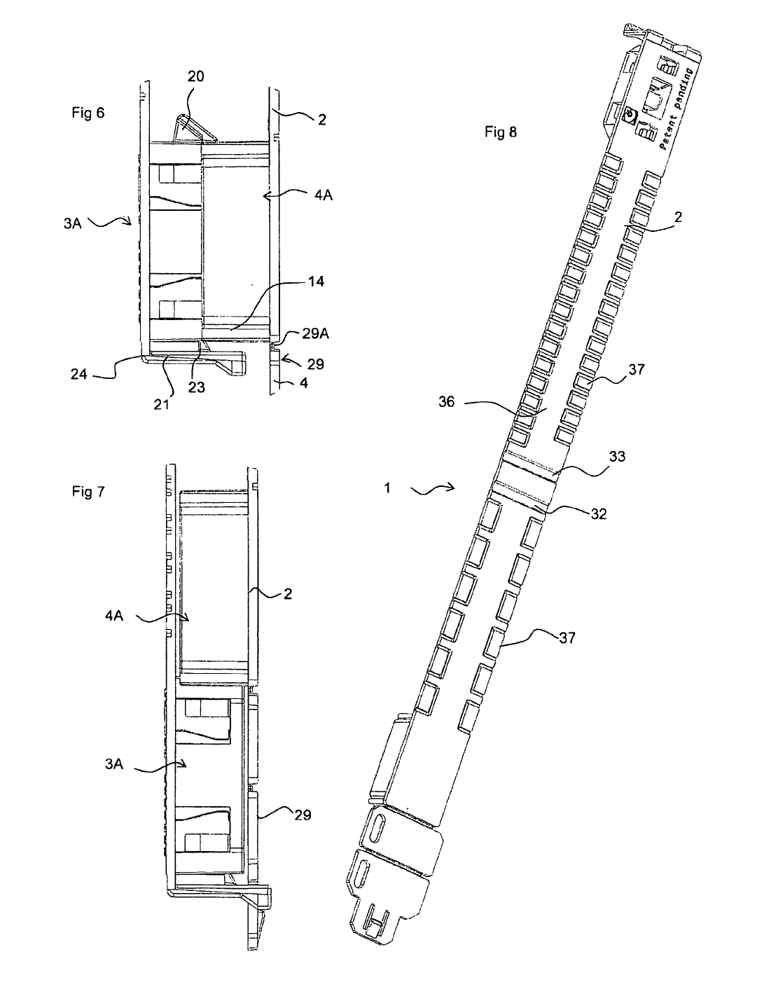

As shown in FIG. 2, on another outer wall 19 of the frame 14, opposite the wall 22, a hook 20, arranged to keep the two ends 3, 4 of the band 2 together in a transport position which will be described in more detail below, projects. FIG. 7 shows the strap 1 in a transport position according to which the band 2 is bent in the area of the two hinge areas 32, 33, substantially centered on the band 2 and spaced apart from one another along the longitudinal direction X. In its transport position, the strap is thus closed on itself but the two closing assemblies 3A and 4A are placed with the end portion 29 which covers the top of the first closing assembly 3A. The hook 20 provided on the closing assembly 3A is engaged in the area of the arch frame 30 of the closing assembly 4A, whereas the tab 21 penetrates inside the band 2 in the area of the slot 35. In this position, the strap takes little space, which facilitates its transport or storing.

FIG. 8 shows the rear surface of the band 2 which is opposite the front surface on which the two closing members 5, 6 are arranged. This rear surface of the band is provided with a marking or identification device 36. The marking device 36 can, for example, be made with an engraving technique, for example, laser or mechanical engraving, or with a printing technique with any type of ink, printable on plastic. A marking device 36 constituted of cutouts 37 in the band 2 can also be provided, for example twelve cutouts corresponding to the twelve months in the year and thirty one cutouts corresponding to the days of a month in the year. The marking device 36 can also be made in electronic form (not shown), for example in the form of an RFID chip glued, welded, or over-molded in the band 2. The RFID chip can also be placed anywhere on the band, including in the area of the closing assemblies 3A, 4A.

The strap 1 according to the invention can be made by molding one or several plastic materials, for example injectable thermoplastic polymers, for example by means of plastic injection molds on injection-molding machines. A polyamide having a 6.6 quality can preferably be used. Preferably, the strap 1 is made in one piece of a single molded plastic material. This plastic material is strong enough to resist mechanical tension forces, which makes it possible, for example, to pull the animal with the strap according to the invention.

Naturally, the invention is not limited to the preceding description of one of its embodiments, susceptible of being the object of several modifications without for that matter leaving the scope of the invention.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1-9. (canceled)

10. A strap, comprising:
a band having first and second ends;
a first closing member including a first male portion and a first female portion adapted to be inserted one into the other to connect said first and second ends of said band in order to close said strap, said first male portion and said first female portion arranged respectively on said first and second ends; and
a second closing member including a second female portion and a second male portion adapted to be inserted one into the other to connect said first and second ends of said band in order to close said strap, said second female portion and said second male portion arranged respectively on said first and second ends;
said second closing member at least partially surrounding said first closing member.

11. The strap of claim 10, wherein said first male portion and said first female portion of said first closing member comprise respective first notches engageable with one another in a first locking position to prevent withdrawal of said first male portion from said first female portion, and said second male portion and said second female portion of said second closing member comprise respective second notches engageable with one another in a second locking position to prevent withdrawal of said second male portion from said second female portion, said first and second closing members lockable simultaneously.

12. The strap of claim 10, wherein said first closing member comprises first flexible notches disposed along a first direction and wherein said second closing member comprises second flexible notches disposed along a second direction perpendicular to said first direction.

13. The strap of claim 10, wherein said first male portion of said first closing member and said second female portion of said second closing member form a first closing assembly arranged at said first end of said band and said second male portion of said second closing member and said first female portion of said first closing member form a second closing assembly arranged at said second end of said band.

14. The strap of claim 10, further comprising means at said first and second ends of said band for preventing complete insertion of at least one of said first and second male portions into a corresponding said first and second female portion of said closing members when said strap is closed on itself.

15. The strap of claim 14, wherein said means comprises a tab connected to said band by a divisible material area.

16. The strap of claim 10, further comprising means for keeping said strap closed on itself in a transport position in which respective said male and female portions of said closing members are not inserted one into the other.

17. The strap of claim 10, further comprising a marking device, said marking device one of printed on a surface of said band, welded in said band, and over-molded in said band.

18. The strap of claim 10, wherein said band and said first and second closing members are made of plastic material and are molded in one piece.
